(19) United States
(12) Patent Application Publication
(10) Pub. No.: US 2014/0055784 A1
(43) Pub. Date: Feb. 27, 2014

(54) CAMERA SYSTEM FOR CAPTURING TWO-DIMENSIONAL SPATIAL INFORMATION AND HYPER-SPECTRAL INFORMATION

(71) Applicant: Logos Technologies, LLC, Fairfax, VA (US)

(72) Inventors: Richard M. KREMER, Ramona, CA (US); Mark SALVADOR, Brandywine, MD (US)

(73) Assignee: Logos Technologies, LLC, Fairfax, VA (US)

(21) Appl. No.: 13/973,435

(22) Filed: Aug. 22, 2013

Related U.S. Application Data
(60) Provisional application No. 61/692,250, filed on Aug. 23, 2012.

(51) Int. Cl. G01J 3/28

(52) U.S. Cl. CPC G01J 3/2823
USPC 356/302

(57) ABSTRACT

An spectrometer having a first lens, a perforated focal plane mask having a front surface and rear surface and a plurality of perforations, the first lens configured to focus incoming radiation onto a front surface of the focal plane mask, each of the perforations of the focal plane mask causing a radiation beam that is emitted from the rear surface of the focal plane mask, a dispersing element receiving the radiation beams and configured to disperse each of the radiation beams into dispersed radiation beams, a second lens, and a focal plane array, the second lens configured to focus the dispersed radiation beams onto the focal plane array.

### CROSS-REFERENCE TO RELATED APPLICATIONS

This application claims priority to the provisional patent application with the Ser. No. 61/692,250 that was filed on Aug. 23, 2012, the contents thereof being herewith incorporated by reference.

### FIELD OF THE INVENTION

The present invention is directed to the field of hyper-spectral imaging, and spectral analysis of images, hyper-spectral spectrometers, spatially-resolved two-dimensional spectroscopy and spectral imaging and data analysis.

### BACKGROUND

In the field of spectroscopy, a slitless spectrometers have been proposed that are commonly used for astronomical applications, in which radiation is captured without the use of a small slit that was conventionally used to narrow beam of light that enters a spectroscope, and allowed that only light from a small region is captured. In contrast, with slitless spectrometers, radiation is captured over the entire field of view. The slitless spectrometer works best in sparsely populated fields of radiation sources, as it spreads each point source out into its spectrum. As an example, a slitless spectrometer has been used, to capture and analyze radiation from a star as a source. However, the slitless spectrometers have several disadvantages. Spectra of different sources having different positions may overlap, and it is difficult if not impossible to properly modulate of the resolving radiation power of different sources. In this respect, it may be impossible or difficult to compute any spatial information that is related to the captured spectral information of the different sources, and will require high computational power and short latency times for real-time analysis or imaging. Therefore, there is a strong need for improved hyper-dimensional spectral imaging solutions.

### SUMMARY

In one aspect of the present invention, an optical system is provided. The optical system preferably includes a first lens, a perforated focal plane mask having a front surface and rear surface and a plurality of perforations, the first lens configured to focus incoming radiation onto a front surface of the focal plane mask, each of the perforations of the focal plane mask causing a radiation beam that is emitted from the rear surface of the focal plane mask. Moreover, the optical system preferably further includes a dispersing element receiving the radiation beams and configured to disperse each of the radiation beams into dispersed radiation beams, a second lens, and a focal plane array, the second lens configured to focus the dispersed radiation beams onto the focal plane array.

According to another aspect of the present invention, a spatially resolved spectral analysis method is provided. The method preferably includes the steps of focusing incoming radiation onto a perforated focal plane mask by a first lens arrangement, the focal plane mask having a plurality of perforations, causing a plurality of radiations beams exiting from the perforated focal plane mask, each radiation beam exiting from a corresponding perforation of the focal plane mask, and passing the plurality of radiations beams via a dispersing element to generate a plurality of dispersed radiation beams, each corresponding to a respective radiation beam. Moreover, the method preferably further includes the steps of focusing the plurality of dispersed radiations beams onto a focal plane array by a second lens arrangement to generate a plurality of projections, each of the projections being formed at a respective reception area of the focal plane array, the reception area having a matrix of pixels; and capturing pixel value information of the plurality of reception areas having the plurality of projections, respectively.

### BRIEF DESCRIPTION OF THE SEVERAL VIEWS OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 depicts a schematic cross-sectional view of the spectrometer for capturing hyper-spectral image information;

FIG. 2 depicts a schematic exploded view of a radiation beam path between the perforated focal plane mask and the focal plane array;

FIG. 3 depicts a schematic perspective view of an area of the focal plane mask that receives the dispersed radiation beam;

FIG. 4 depicts a schematic cross-sectional view of the spectrometer for capturing hyper-spectral image information according to another embodiment;

FIG. 5 depicts a schematic exploded view of a radiation beam path via a perforated focal plane mask and a focal plane array according to yet another embodiment;

FIG. 6 depicts a close-up cross-sectional view of a microlens array and combined perforated focal plane mask and dispersion element according to still another embodiment;

FIG. 7 depicts a close-up cross-sectional view of a combined microlens array, perforated focal plane mask, and dispersion element according to a further embodiment;

FIG. 8A depicts a schematic cross-sectional view of the spectrometer for capturing hyper-spectral image information according to another embodiment; and

FIG. 8B depicts a schematic front view of an area of the focal plane mask that receives the dispersed radiation beam.

The drawings provided are for illustration purposes only and the actual dimensions shown are not necessarily depicted to scale.

### DETAILED DESCRIPTION

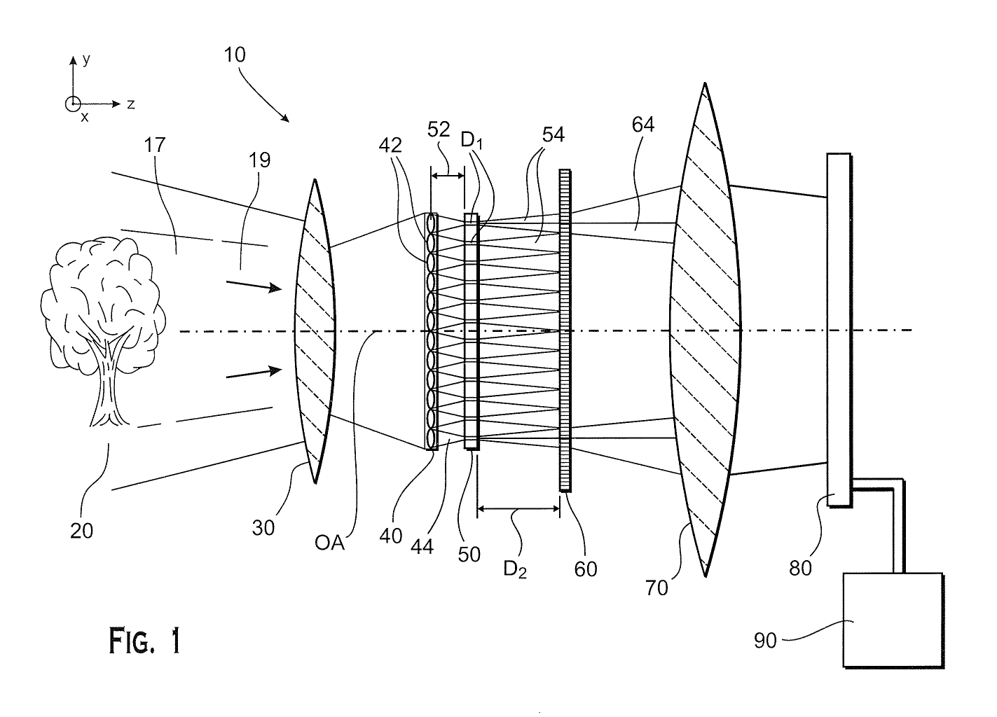

FIG. 1 shows a schematic cross-sectional view of the spectrometer, spectroscope, or spectral camera system 10 according to an embodiment of the present invention. For description purposes, the description below and the figures makes reference to a three-dimensional Cartesian coordinate system that is depicted in the figures, in which the z direction or axis is defined as a direction of main propagation of the radiation, and the x and y direction or axis define a plane that is perpendicular to the z direction. Surfaces that face towards the negative z direction are herein described as being frontal or top surfaces, while surfaces that face the positive z direction are described as being rear or back surfaces.

Spectrometer 10 consists of a first focusing lens 30, a microlens array 40, a perforated focal plane mask 50, a radiation dispersing element 60, a second focusing lens 70, a focal plane array 80, and a signal processing device 90. First focusing lens 30, microlens array 40, perforated focal plane mask 50 having a plurality of perforations, radiation dispersing element 60, second focusing lens 70 and focal plane array 80 are shown to be arranged along an optical axis OA. An object or scenery 20 under inspection is located in the field of view 17 of first focusing lens 30, and first focusing lens 30 is configured to focus incoming radiation 19 from object 20 onto a frontal surface of the microlens array 40. Microlens array 40 refocuses incoming radiation 19 to generate an array of radiation beams 44 that are received on a front surface of a perforated focal plane mask 50. Microlens array 40 includes a microlens 42 for each perforation 52 of the perforated focal plane mask 50, and the optical properties of a microlens 42 and distance D₁ between microlens array 40 and perforated focal plane mask 50 are such that incoming radiation is focused substantially by microlens 42 onto the aperture of the corresponding perforation 52, so increase the optical efficiency of spectrometer 10. For example, microlens 42 could be designed such that a diameter of radiation beam 44 arriving at perforation 52 is smaller than aperture A of perforation 52. Alternatively, no microlens array 40 is present, and the incoming radiation 19 can be directly focused onto a frontal surface of the perforated focal plane mask 50 by first focusing lens 30. In the present specification, the term radiation signifies electromagnetic waves that are emitted from an object 20, and can include visible light, infrared radiation, ultraviolet radiation, and other wavelengths that are of interested for spectral analysis.

In the variant shown, microlens array 40 is formed of n₁ to m₁ microlenses 42 that are arranged adjacent to each other in x and y directions to form a rectangular grid or matrix of the dimensions n₁ to m₁, for example the microlenses 42 affixed to a substrate that is substantially transparent to the radiation, each of the microlenses 42 having an optical axis in the z direction parallel to OA. Analogously, perforated focal plane mask 50 is formed of a rectangular grid or matrix of n₁ to m₁ perforations 52 that are spaced apart so that each perforation 52 corresponds to a microlens 42. Dimensions n₁ to m₁ form a first spatial, two-dimensional resolution of the spectral camera system 10, for example, microlens array 40 and perforated focal plane mask 50 can be made having a resolution of n₁=512, and m₁=512. Together with the optical geometry given by first focusing lens 30 and microlens array 40, each perforation 52 having a different coordinate in the x and the y direction of perforated focal plane mask 50 can be associated with a different viewing direction, including inclination angle θ measured from the optical axis and the azimuth angle Φ, as measured in the plane that is perpendicular to optical axis OA. Depending on the field of view 17 and location/size of object, different viewing directions will point onto specific location on object 20, and can be associated with two or three-dimensional coordinates of locations on object 20.

Perforated focal plane mask 50 can be made of a substrate of a material that is not transparent to incoming radiation 19, having micropores as perforations 52 of a small size, having an aperture A or diameter in a range of 1 μm to 50 μm arranged in a rectangular grid or matrix, spaced apart in y direction by a distance M_{y} preferably in a range of 5 μm to 100 μm, and in the x direction by a distance Mₓ preferably in a range of 5 μM to 100 μm. However, other dimensions are also possible. In the variant shown, M_{y} and Mₓ are chosen to be equal, but it is also possible to have unequal distance M_{y} and Mₓ between perforations 52, for example in a concentric arrangement of perforations 52, with the inner perforations being closer to each other than the outer perforations, resembling an arrangement of the optical nerves of the retina of the human eye. Analogously, the microlenses 42 of the microlens array 40 would be arranged the same way. The perforations 52 or micropores can also be filled with optical fibers that are pressed inside the micropores, to form micropillar arrays, as long as this material is transparent to the radiation 19. Alternatively, perforated focal plane mask 50 can be made of a transparent glass substrate that has a non-transparent layer deposited thereon, and thereafter, a pattern of openings serving as the perforations 52 is etched into the non-transparent layer. Also, it is possible that perforations 52 are microholes that have been drilled by a laser ablation technique.

Next, radiation in the form of an array or bundle of radiation beams 44, or if no microlens array 40 is present, as a single radiation beam 44, passes via perforations 52 of perforated focal plane mask 50 to form individual radiation spot beams 54 that exit from back surface of perforated focal plane mask 50, and continue to propagate towards radiation dispersing element 60, with a distance D₂ between perforated focal plane mask 50 and dispersion element 60 or diffraction element. D₂ can be chosen such that dispersion element 60 lies anywhere between plate 50 and lens 70. Radiation dispersing element 60 is configured to disperse or diffract the individual radiation spot beams 54 into dispersed beams 64 having a dispersion direction DD, spreading out the spectral content of radiation spot beam 54 into different spectral components each having a different propagation direction. For example, dispersing element 60 can be, but is not limited to, a transmissive diffraction grating, a microprism array, conventional prism, a prims having grated surface (grism). In other words, dispersing element 60 is configured to spread out radiation from each radiation spot beam 54, composed of radiation of different bandwidths, into its constituent spectral elements, to form dispersed beams 64.

In case a transmissive diffraction grating is used as shown in FIG. 1, an optical substrate can be used that has a linear grating, the spacing between the individual grating lines being GS, and having a grating orientation OG, in the variant shown being parallel the y direction. GS is chosen based on the application, and which wavelengths need to be analyzed. Grating lines can be made as a series of parallel grooves or depressions, or by non-transparent slit lines, for example by depositing a non-transparent layer on the substrate. If a microprism array is used as dispersing element 60, each radiation spot beam 54 associated with perforation 52 will pass through an individual microprism that is arranged to intersect the respective radiation spot beam 54. In the variant shown, the dispersion characteristics of dispersing element 60 is the same for all of the perforations 52, but in a variant, it is also possible to have different dispersion characteristics for different radiation sport beams 54. Next, dispersed beams 64 that exit from rear surface of dispersing element 60 are collectively focused by second focusing lens 70 on to a focal plane array 80. Second focusing lens 70 is configured to have the required magnification/minification ratio so that the radiation of dispersed beams 64 are received by an active upper surface or pixels of focal plane array 80 and having a focal distance fd towards focal plane array 80. Preferably, second focusing lens is an isomorphic lens or a cylindrical lens that allows to provide beam shaping of dispersed beams 64 in the dispersion direction.

Focal plane array 80 is connected to a data input and processing device 90, that is configured to read out the data values of the pixels of focal plane array 80, for example as a full-resolution image, including but not limited to, analog signal processing, analog-digital conversion, image capturing synchronization, pixel readout, pixel value clipping, image calibration, fixed pattern noise removal, data normalization. Moreover, processing device 90 can also be configured to perform various data processing algorithms on the received data, to display image data, and to communicate processed or raw data to other devices. Processing that can be performed by data input and processing device 90 can include, but is not limited to pixel data value averaging, clipping, filtering, mean value generation, median value generation and filtering, spectral analysis algorithms, histogram analysis, coordinate data transformations, projections and mapping to map pixel data of focal plane array 80 to different frequencies and to a corresponding perforation 52 of focal plane mask 50, and to two- or three-dimensional location of the original radiation source on object 20. Processing device 90 can also be connected to a network, a monitor, and a printing device, so as to be able to communicate the data to users or to other devices.

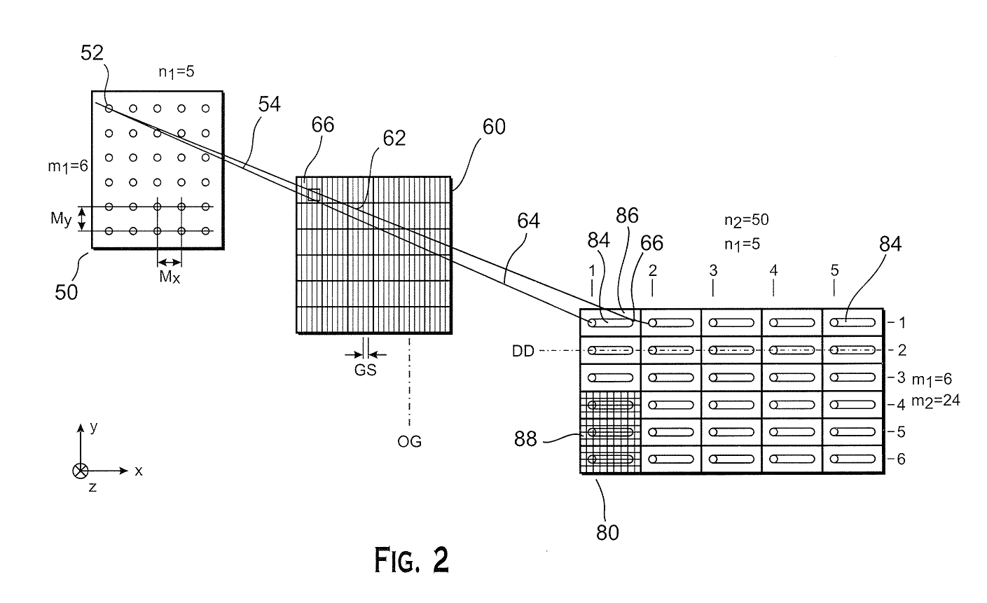

FIG. 2 shows an exploded view of perforated focal plane mask 50, dispersing element 60, and focal plane array 80 of spectrometer 10, with the mask 50 having perforations 52 arranged in a rectangular grid with a resolution of n₁=5 and m₁=6 and with constant distances between adjacent perforations 52, with M_{y} equal to Mₓ between all the perforations 52. For simplification and visualization purposes, a focusing lens between dispersion element 60 and focal plane array 80 is not shown. Moreover, focal plane array 80 has a matrix of pixels having the resolution of n₂=50 and m₂=24. Focal plane array 80 is typically implemented as an image sensor with a matrix of pixels having the resolution of n₂ to m₂, for example a resolution of n₂=4096 to m₂=2048 for a perforated focal plane mask or plate 50 with a resolution of n₁=512 and m₁=512, and the matrix of pixels can be split into individual zones 86, each zone 86 receiving radiation from a corresponding dispersed beam 64. Individual zones 86 are defined such that beam projection 66 of each dispersed beam 64 form projection area pixels 84 that remain inside zone 86, and there is substantially no overlap of beam projections 66. A little overlap of beam projections 66 can be tolerated that is due to stray light, or the dispersion and optics can be designed such that bandwidths that are not used for an analysis can overlap on focal plane array 80. In the variant shown, each zone 86 consists of a matrix of n₃=4 to m₃=10 pixels, and the projection area pixels 84 has a length in the dispersion direction DD of about 6 pixels, and zones 86 are a submatrix of pixels being part of the overall matrix of the focal plane array 80. It is also possible that zones 86 are formed by individual or separate focal plane arrays that are integrated on the same substrate or chip, or being entirely separate sensors.

The number n₁ of the spatial resolution in the x direction of the perforated focal plane mask 50 is larger than the number n₂ of the pixel resolution of focal plane array 80 in the x direction, for example by a factor fₙ, in a range between 10 and 50, while the number m₁ of the spatial resolution in the y direction of the perforated focal plane mask 50 can be equal or larger than the number n₂ of the pixel resolution of focal plane array 80 in the x direction, typically by a factor fₘ in a range between 1 and 10. This allows to have sufficient resolution to capture the different frequencies of a dispersed beam 64 along the dispersion direction DD. Accordingly, preferably, the increase of resolution of the focal plane array 80 as compared to the resolution of the perforated focal plane mask 50 is higher in a direction that is perpendicular to the grating orientation OG, or in a dispersion direction DD, as compared to a direction that is parallel to grating orientation OG, so that pixels of focal plane array 80 can capture the different wavelengths of the dispersed beams with a higher resolution. In a case where factor fₘ is 1, which means that there is only one row of pixels arranged along the dispersion direction DD for each zone 86, it is possible that each pixel of focal plane array 80 have a rectangular longitudinal shape with its longitudinal extension being perpendicular to the diffraction direction DD so that a single pixel can still capture all the radiation of the wavelengths at the respective location along the x direction. This signifies that such pixel would be wider than a width of the beam projection 66 in transversal direction to DD. With factor fₘ being 1, it is also possible that the row of pixels of each zone 86 are arranged as a line that follows the dispersion direction DD of beam projection 66. In such variant, focal plane array 80 could consists of an array of individual linear photosensors instead of a full resolution matrix sensor.

The main dispersion direction of beams 64 by virtue of passing diffraction grating 60 is perpendicular to the extension direction of grating lines 62. In the variant shown in FIG. 2, the extension direction of grating lines 62 is in the y direction, and the main dispersion direction DD of beams 62 is in the x direction. For example, as shown in FIG. 2, the orientation OG of the grating lines 62 is parallel to the y direction, and the main dispersion direction DD of the projections 66 of the dispersed beams 64 onto the focal plane array 80 is perpendicular to the orientation of the grating lines 62, being parallel to the x direction.

In a typical application, the incoming radiation 19 covers at least parts of the wavelengths of visible light including a range of approximately 380 nm to 740 nm, of near infrared (NIR) from approximately 740 nm to 3 μm, and of ultraviolet (UV) from approximately 10 nm to 380 nm, but can also encompass other wavelengths that are detectable by focal plane array 80. Focal plane array 80 can be chosen based on the wavelengths that need to be detected and analyzed for its spectral composition. For example, for the detection of visible light and parts of the NIR range, a charge-coupled device (CCD) or a complementary metal oxide semiconductor (CMOS) image sensor can be used. Focal plane array 80 can be operated in a full frame mode, and the pixels of all the zones 86 can first be integrating incoming radiation, and then the entire focal plane array 80 is read out, so that a full-resolution data set is available at the memory of processing device 90. Instead of using an image sensor such as a CCD or a CMOS imager as the focal plane array 80, it is also possible to use a specific spectral matrix sensor for the desired wavelengths that need to be analyzed, for example but not limited to cooled or uncooled infrared sensor array for detecting and analyzing thermal spectra, short wavelength infrared cameras (SWIR), ultraviolet cameras.

Data from the pixels of the focal plane array 80 can be represented as an image referenced to a Cartesian coordinate system, includes an n₁ to m₁ matrix of projections 66 having a longitudinal shape extending along the dispersion direction DD. Spectral information for a spectral bandwidth for each viewpoint associated with a perforation 52 is thereby available as pixel data. Alternatively, it is possible to use a focal plane array that allows to selectively read individual columns or even pixels, and in such variant, only columns or pixels can be read out that actually have pixels that are part of the projection area pixels 84, to speed up the read-out process, and also to reduce the quantity of data that has no useful information.

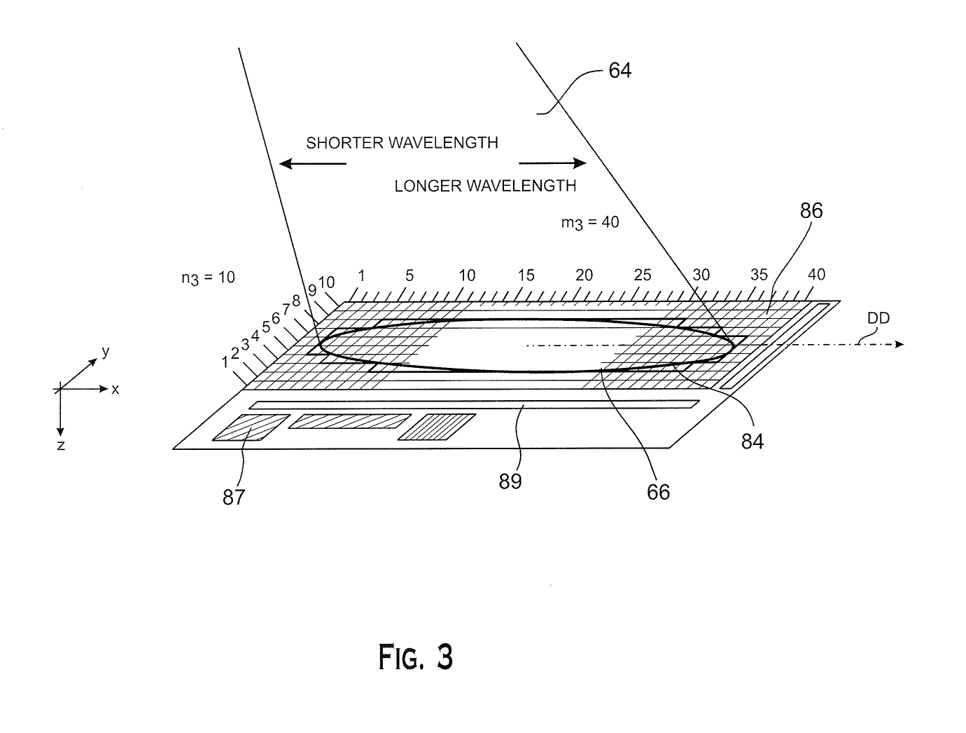

FIG. 3 shows a close-up perspective view of a single, exemplary dispersed beam 64 that impinges on an upper surface of focal plane array 80 to form beam projection 66. Dispersed beam 64 has been dispersed mainly in the dispersion direction DD that is parallel to the x direction by virtue of the grating direction OG that is perpendicular thereto, with the longer wavelengths arriving at the upper surface of focal plane array 60 at higher x coordinates, and the shorter wavelengths arriving at lower x coordinates. Each beam projection 66 has a longitudinal shape that impinges on longitudinally-shaped projection area pixels 84 that are part of an active area of pixels of focal plane array 80. Due to the longitudinal dispersion of beam 64 along an axis DD, beam projection 66 will impinge on a large number of pixels along the dispersion direction DD, in this case the x direction, but substantially fewer pixels in a direction that is transverse to DD. In the variant shown, beam projection 66 covers thirty-six (36) pixels in the x direction, and only six (6) pixels in the y direction, for area 86 having matrix of pixels of n₃=10 and m₃=40. In this variant, there is no radiation that is received laterally between adjacent beam projections 66 in a transversal direction to DD. Therefore, instead of having useless pixels arranged in these areas, different functional components could be arranged in these areas, for example vertical and horizontal readout drivers and readout circuits 89, microprocessors 87 and local buffer or preprocessing memory for local pre-processing of data from pixel area 86. For example, processor 87 could be used to average all the pixels to generate a mean pixel value for each column in the y-direction, and apply a median value filter to all pixels in the same column, to generate a representative data value for each wavelength, to apply a normalization filter, to correct fixed pattern noise. Also, due to the nature of having separate drivers and circuits 89, each pixel area 86 of the entire focal plane array 80 can be readout and preprocessed in parallel, and synchronized together.

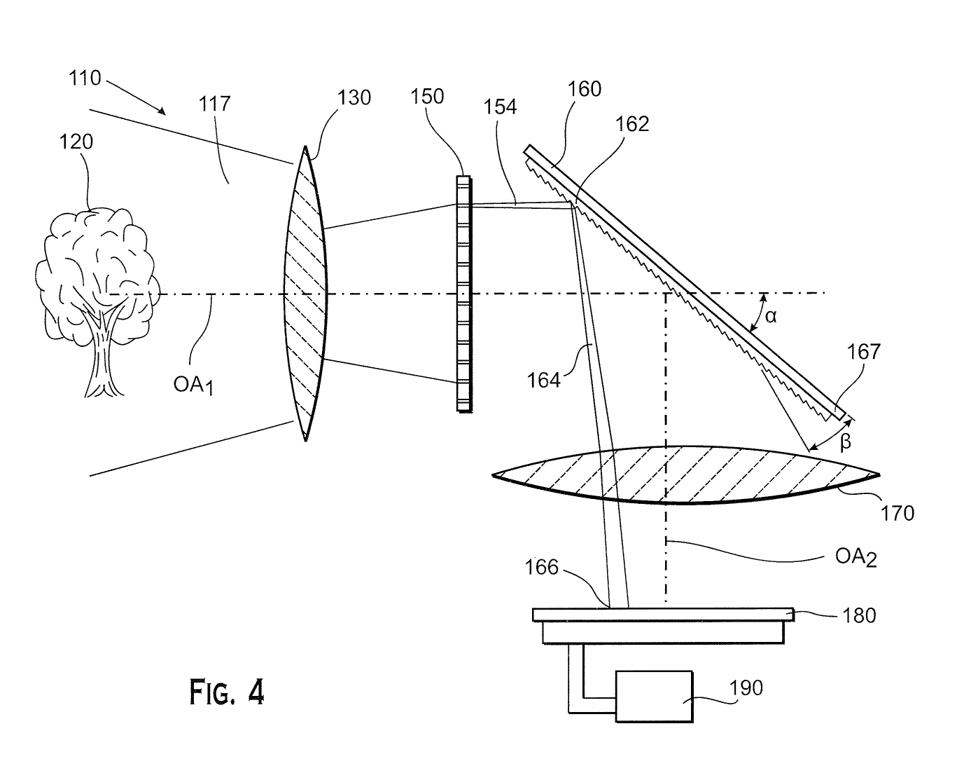

FIG. 4 shows a schematic cross-sectional view of the spectrometer 110 according to another embodiment, in which the to-be-observed object 120 is arranged in the field of view 117 of a first focusing lens 130, and a perforation focal plane mask 150 that is configured to generate an array or bundle of individual radiation spot beams 154. The radiation spot beams 154 then impinge upon a reflective dispersion element 160, in the variant shown a microprism array that is made of a carrier substrate 167 having a reflective surface facing the incoming radiation spot beams 154, and an array of microprisms 162 that are mounted on the reflective surface of the carrier substrate 167. The reflection and dispersion created by reflective dispersion element 160 generates an array or bundle of dispersed beams 164 that are refocused by a second focusing lens 170 onto a focal plane array 180. In the variant shown, the spectrometer 110 has two main optical axes, namely a first optical axis OA₁ that is defined by first focusing lens 130, and a second optical axis OA₂ that is defined by the angle of orientation α of the reflective dispersion element 160, and the slope angle β of the microprisms 162, causing a wavelength-dependent dispersion angle γ. Each dispersed beam 164 forms a beam projection 166 on an active surface of pixels of the focal plane array 180. A processing device 190 is connected to focal plane array 180 for pixel data readout, conversion, and data processing.

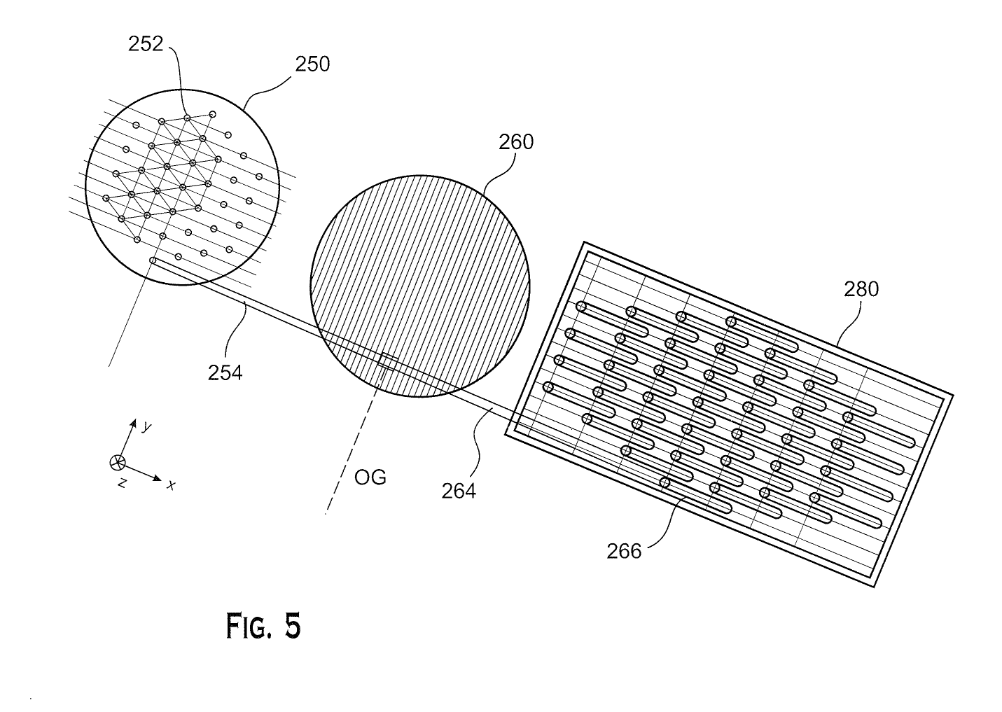

FIG. 5 depicts schematic exploded view of a radiation beam path via a perforated focal plane mask 250, dispersion element 260, and focal plane array 280 according to yet another embodiment. For simplification and visualization purposes, a focusing lens between dispersion element 260 and focal plane array 280 is not shown. Perforated focal plane mask 250 has a circular shape having an arrangement of perforations 252 in a triangular grid pattern. Perforations 252 generate radiation spot beams 254 that traverse dispersion element 260, in the variant shown a transmissive grated disc with adjacent grating lines being equidistant to each other. Grating orientation OG is such that it is parallel with one of the symmetry axes of the hexagon formed by the triangularly-arranged perforations 252. Dispersed beams 264 are generated that are received by pixels for each beam projection 266 on focal plane array 280. Due to the dispersion of the beams in dispersion direction DD being in the x axis, for all beam projections 266 of each dispersed beam 266 to fit onto the active surface of focal plane array 280, focal plane array 280 is made with a form factor of 2 to 1, with more pixels arranged along the x direction than the y direction. Because no beam projection 266 are formed in corners of the active surface of focal plane array 280, in a read-out operation for reading out the values for pixels, it is possible to avoid reading out these areas as they do not contain any valuable information.

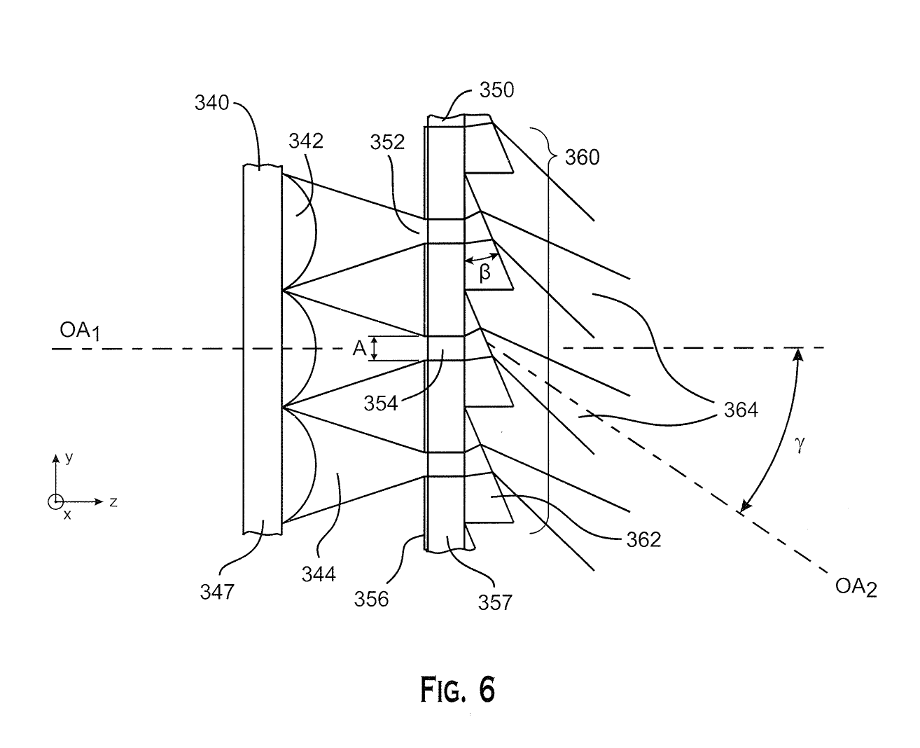

FIG. 6 depicts a close-up cross-sectional view of a microlens array 340 and combined perforated focal plane mask 350 and dispersion element 360, according to still another embodiment. Microlens array 340 is made of a substrate 347 that is transparent to the wavelengths or spectra of the radiation that is to be measured and analyzed. Microlenses 342 are bonded to the rear surface of substrate 347. It is also possible that microlenses 342 and substrate 347 are made of a single, integral optical substrate. Each microlens 342 generates a radiation beam 344 that is focused onto an aperture or diameter A of perforations 352. Perforations 352 are formed by depositing a mask 356 that is non-transparent to the radiation onto a front face of transparent substrate 357, and then mask is removed at specific locations to form perforations 352 that are transparent to the radiation. Microprisms 362 are bonded to the rear face of transparent substrate 357, having each the slope angle β to form a dispersion element 360 that is integral with the perforation focal plane mask. It is also possible that microprisms 362 and substrate 357 are formed from the same integral optical substrate. By virtue of slope angle β and the change of the main optical axis OA₁ by the microprisms 362, a second optical axis OA₂ is defined. In this embodiment, because of combined perforated focal plane mask 350 and dispersion element 360 via the common substrate 357, alignment problems during manufacturing between perforations 352 and corresponding microprisms 362 can be prevented, and due to the short optical path of radiation spot beams 354 that does not exit the optical medium formed by substrate 357 and microprism 362, optical efficiency can be increased by minimizing reflection, and parasitic dispersion of the radiation due to dust, manufacturing imperfections, surface imperfections, impurities etc. can be decreased.

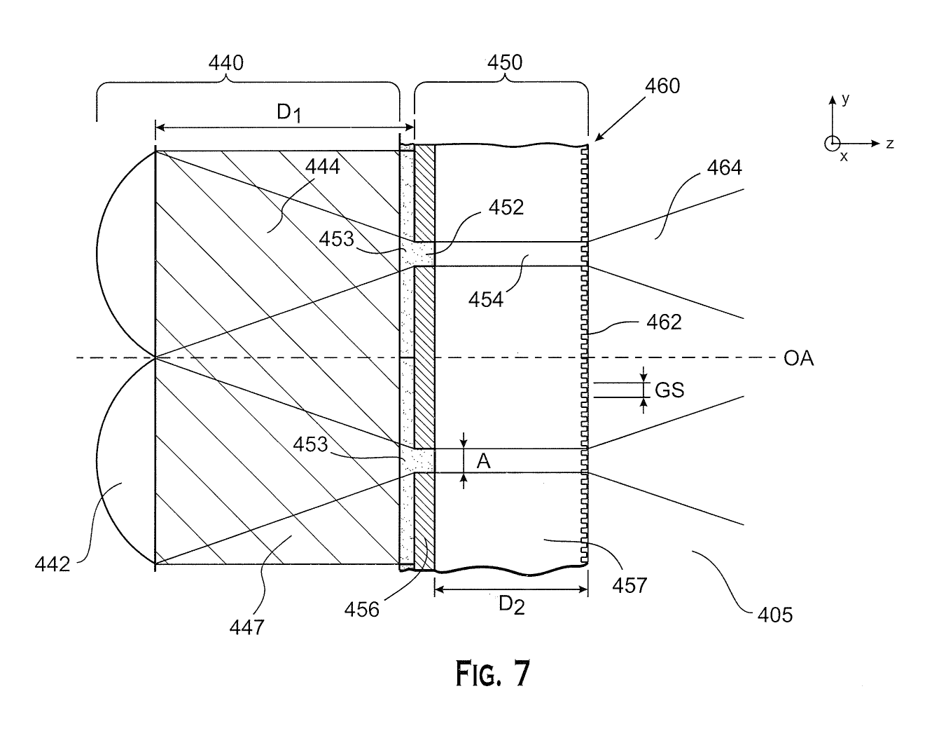

FIG. 7 depicts a close-up cross-sectional view of a laminated optical device 405 that can be a part of the spectrometer 110 discussed above, combining microlens array 440, perforated focal plane mask 450, and dispersion element 460 into an integral optical device, according to a further embodiment. A first transparent substrate 447 is arranged with microlenses 442 arranged on the front face of substrate 447 forming the microlens array 440 that generates radiation beams 444 that propagate inside substrate 447, having a thickness D₁. At the rear face of microlens array 440, the perforated focal plane mask 450 is arranged, made of non-transparent mask 456 with perforations 452 that is located at a front face of transparent substrate 457. Perforations have a diameter or aperture A. Moreover, at the rear face of the same transparent substrate 457, gratings are arranged to form dispersion element 460. Grating slits 462 have a spacing GS, and in the variant shown are arranged parallel to the x direction. Therefore, a single substrate 457 serves as a carrier for both the perforation plate to generate individual radiation spot beams 454, but also to implement the dispersion element 460, to avoid optical losses. Thickness of substrate 457 is chosen to be D₂ being in a range that allows to produce an optically efficient and cost-effective substrate.

Moreover, between microlens array 440 and perforated focal plane mask 450, individual radiation filters 453 are arranged. In the variant shown, radiation filters 453 are deposited to a front face of perforated focal plane mask 450, such that radiation filters 453 fill the voids provided by perforations 452, and a front face of filters 453 is in directed contact with rear face of substrate 447. Bandpass filters 453 can have the same optical characteristics for all of the perforations 452 thereby forming an integral layer, for example to form a low-pass filter, high-pass filter or a band-pass filter, but can also be different from perforation to perforation 452, for example to for a specific filter pattern, such as an RGB color filter pattern. In such case, radiation filters are individual elements for each perforation, or can be made as linearly-extending filters to cover rows or columns of perforations 452, for example by extending in either x or y direction. With the variant shown in FIG. 7, many radiation or optical elements are integrated into the same optical laminate 405, to improve the transmissive efficiency, reduce losses due to reflection and parasitic dispersion or diffraction. For example, by arranging radiation filters 453 directly at the individual perforations 452, it can be ascertained that only the desired wavelengths of radiation pass via a respective perforation, and there is no parasitic scattering or diffraction of other wavelengths into the radiation spot beams 454. Also, by the use of only two substrates 447, 457, costs can be reduced, alignment problems between microlenses 442, perforations 452, and grating slits 462 can be prevented. Moreover, the absence of and air gap, or other substrate-to-gas interfaces, parasitic diffraction and reflection can be reduced. For operation, the optical laminate 405 can also improve ruggedness and impurities contamination. In a variant, it is also possible that substrate 457 is actually made of two substrates that are bonded to each other, one substrate having the perforations 452, the other substrate having the dispersion elements 460 in form of gratings 462 or microprisms.

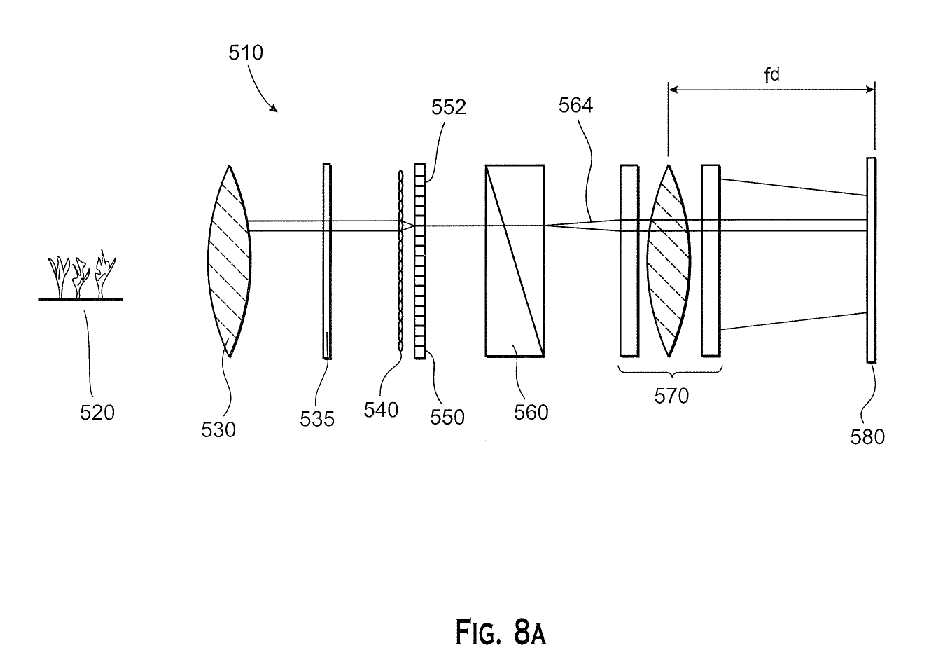

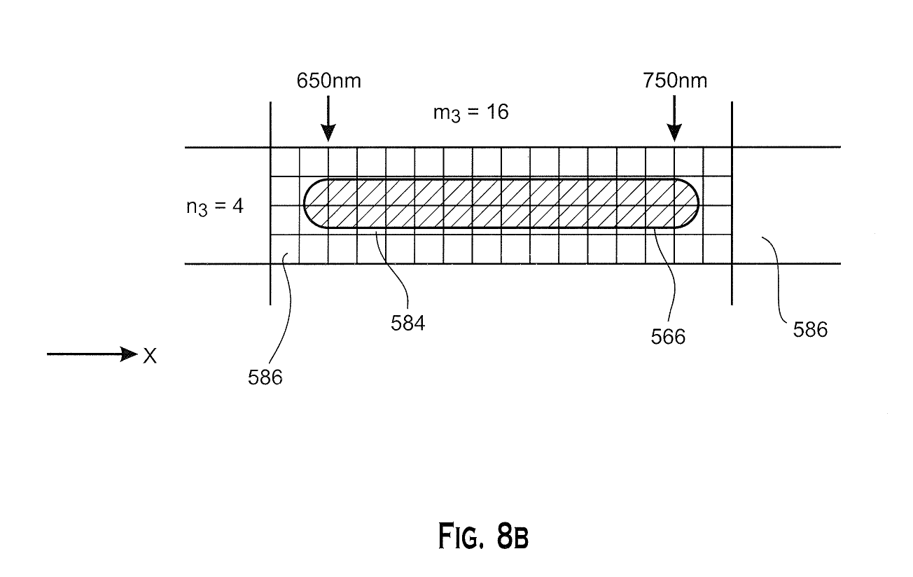

FIG. 8A depicts a schematic cross-sectional view of the spectrometer 510 for capturing hyper-spectral imaging information according to another embodiment. The spectrometer 510 shown is suitable for the particular application for the monitoring of agriculture plants 520 to observe the so-called “red-edge” spectral region, being a region of fast change in reflectance of vegetation between red light and the NIR range of the radiation spectrum. Chlorophyll in healthy plants absorb about 95% of the light that it receives below the 700 nm wavelengths, but becomes almost transparent at wavelengths greater than 700 nm in the NIR range. Vegetation cellular structure takes its major part in the reflectance because each cell acts like an elementary corner reflector. This leads to a fast change of reflectance that can be from 5% to 50% reflectance in the bandwidth between 650 nm to 750 nm. In order to monitor this transition in this red-edge spectral area, about 7 to 14 spectral bands have to be observed by spectrometer 510, preferably with the spectral bands being evenly spaced apart between 650 nm to 750 nm, with a spatial resolution for identifying a location of healthy and unhealthy plants of about 1 m. Spectrometer 510 consists of a objective 530 for focusing onto an area with agriculture plants 520, a band-limiting filter 535 being a 100 nm band-pass filter centered at 700 nm, a microlens array 540 having a matrix of microlenses arranged in a square grid with a resolution of n₁=250 to m₁=250, a perforated focal plane mask 550 having perforations 552 arranged with the same resolution, and a zero deflection prism 560 to cause dispersed beams 564. Each dispersed beam 564 will contain the spectral information required for a position in the field of view of objective 530, being a matrix of 250 to 250 positions of the area in an agriculture field that covers agriculture plants 520. Dispersed beams 564 are refocused by a isomorphic lens system 570, and the radiation is received by a focal plane array or image sensor 580 having a resolution of n₂=1000 to m₂=4000 pixels with a pixel pitch 7.5 μm, and being sensitive to at least the red edge band.

Each microlens is arranged such that its optical axis matches a position of the corresponding perforation 552, and aperture or diameter A of perforation 552 is near to the diffraction limited focal size of the objective 520. Zero deflection prism 560 is chosen to disperse 100 nm over about 14 pixels of focal plane array 580, and with a focal distance fd=3 cm of isomorphic lens system 570, a dispersion angle γ is about:

$$\frac{1}{4} \frac{14 \cdot 7.5 μm}{3 cm} = 0.15 °$$

The isomorphic lens system 570 accomplishes two tasks, by focusing the image emerging from the perforated focal plane mask 550 onto the focal plane array 580, while at the same time stretching the image in the dispersion direction DD by approximately a factor four (4) as compared to a cross-direction of dispersion, or a direction perpendicular to DD. This allows to stretch beam projection 566 so that more pixels are provided for spectral analysis, resulting in more projection area pixels 584 in the x direction, as shown in FIG. 8B. In addition, it allows to match the initially squared shaped image from the perforated focal plane mask 550 to match with the different form factor of the rectangular focal plane array 580.

Moreover, as further shown in FIG. 8B, by dispersed beams 564 that impinge in different areas 586 of focal plane array 580, areas 586 are arranged as a sub-matrices of the focal plane area 580, having each 64 pixels, and resolution of n₃=4 and m₃=16, and because 14 pixels are covered by beam projection 566, it is possible to gather spectral information of 14 different bands. Moreover, because there are 2·14 projection area pixels 584 for each beam projection 566, and areas 586 for each perforation 552 cover the entire active pixel area of focal plane array 580, the pixel use efficiency is about, 28/64=0.4375. Because the adjacent two rows include redundant information on the respective spectrum, it can be said that that the pixel use efficiency is about half, 14/64=0.21875. With a readout and processing device (not shown), the entire active area of pixels of the focal plane array 580 can be read out and further processed for spectral analysis of the spectral bands.

While the invention has been described with respect to specific embodiments for complete and clear disclosures, the appended claims are not to be thus limited but are to be construed as embodying all modifications and alternative constructions that may occur to one of ordinary skill in the art which fairly fall within the basic teachings here set forth.

1. An optical system comprising:
a first lens;
a perforated focal plane mask having a front surface and rear surface and a plurality of perforations, the first lens configured to focus incoming radiation onto a front surface of the focal plane mask, each of the perforations of the focal plane mask causing a radiation beam that is emitted from the rear surface of the focal plane mask;
a dispersing element receiving the radiation beams and configured to disperse each of the radiation beams into dispersed radiation beams;
a second lens; and
a focal plane array, the second lens configured to focus the dispersed radiation beams onto the focal plane array.

2. The optical system according to claim 1, further comprising:
a microlens array located between the first lens and the focal plane mask, each microlens of the microlens array associated with a respective perforation of the focal plane mask, each microlens configured to focus incoming radiation onto a corresponding perforation.

3. The optical system according to claim 1, wherein
the perforated focal plane mask has a matrix of perforations with dimensions n₁ to m₁,
the focal plane array has a pixel resolution of n₂ to m₂,
the dispersing element defines a main dispersion direction,
the dimension n₁ and the resolution n₂ extending substantially parallel to the main dispersion direction,
the dimension m₁ and the resolution m₂ extending substantially perpendicular to the main dispersion direction, and
the relationships n₁<n₂ and m₁≦m₂ is satisfied.

4. The optical system according to claim 1, wherein
the focal plane array and the dispersing element are configured such that each dispersed radiation beam impinges upon the focal plane array at a corresponding reception area such that none of the dispersed radiation beams overlap on the focal plane array.

5. A spatially resolved spectral analysis method, comprising the steps of:
focusing incoming radiation onto a perforated focal plane mask by a first lens arrangement, the focal plane mask having a plurality of perforations;
causing a plurality of radiations beams exiting from the perforated focal plane mask, each radiation beam exiting from a corresponding perforation of the focal plane mask;
passing the plurality of radiations beams via a dispersing element to generate a plurality of dispersed radiation beams, each corresponding to a respective radiation beam;
focusing the plurality of dispersed radiations beams onto a focal plane array by a second lens arrangement to generate a plurality of projections, each of the projections being formed at a respective reception area of the focal plane array, the reception area having a matrix of pixels; and
capturing pixel value information of the plurality of reception areas having the plurality of projections, respectively.
